(19) United States
(12) Patent Application Publication
(10) Pub. No.: US 2004/0017430 A1
(43) Pub. Date: Jan. 29, 2004

(54) Laser processing method and laser processing apparatus

(76) Inventors: Yosuke Mizuyama, Fukuoka (JP); Yosuke Toyofuku, Fukuoka (JP)

Correspondence Address: HARNESS, DICKEY & PIERCE, P.L.C., P.O. BOX 828, BLOOMFIELD HILLS, MI, 48303, US

(21) Appl. No.: 10/401,641

(22) Filed: Mar. 28, 2003

Related U.S. Application Data
(60) Provisional application No. 60/397,760, filed on Jul. 23, 2002.

(51) Int. Cl. B41J 2/16; B23K 26/38

(52) U.S. Cl. 347/47; 219/121.71

(57) ABSTRACT

An ultra-short pulse laser beam output from a laser is diffracted into a plurality of laser beams, and a nozzle plate is scanned with the laser beams at a scanning speed of 40 μm/s to 300 μm/s. A placement position z of the nozzle plate with respect to a direction of an optical path of each laser beam is set to be −20 μm to +25 μm, where z is 0 at a reference position at which a hole diameter of the nozzle is minimum, and z increases as the placement position is moved closer to a source of the laser beam and decreases as the placement position is moved away from the source of the laser beam.

### BACKGROUND OF THE INVENTION

1. Field of the Invention

The present invention relates to a laser processing method and a laser processing apparatus for processing a workpiece with a laser beam, and also to a nozzle plate, an ink jet head and an ink jet recording apparatus manufactured by using the processing method.

2. Description of the Background Art

In recent years, ink jet recording apparatuses have been improved by reducing the size of an ink droplet and by improving the ink droplet flight precision, and ink jet printers have become widespread for office-, SOHO-, and household-use as printing apparatuses that are inexpensive and capable of forming high-definition images.

An ink jet head includes actuators for causing ink to fly, nozzles, ink chambers, etc., and the precision in size and dimension of these components influences the printing performance. Particularly, the nozzle precision has a substantial influence on the image quality and the printing speed.

It is generally known in the art that the ink droplet discharging direction may be deviated or varied if the roundness or the diameter precision of a nozzle hole is poor. Moreover, the ink droplet discharging velocity is dependent on the nozzle depth. Therefore, if the nozzle depth is varied among a plurality of nozzles, the ink droplet discharging velocity is likely to be non-uniform. In view of this, the nozzle specifications are finely designed in the prior art, and forming such nozzles requires a high process precision. Furthermore, there is a demand for reducing the managing cost. Therefore, a technique for manufacturing nozzles satisfying such fine specifications at a low cost has been longed for.

There are various nozzle forming methods. Typical methods include etching, electroplating, punching, and laser processing. The present inventors directed our attention to a processing method using an ultra-short pulse laser as a processing method that is capable of minute and precise processing. Unlike a commonly-used CW laser beam, an ultra-short pulse laser beam has a very short pulse width. In an ultra-short pulse laser process, although the pulse width is short, the amount of energy per pulse is set to be very large so as to process a substance. Such a laser process with a short pulse width and a large energy per pulse is generally called an “ablation process”, and the process mechanism thereof is quite different from that of a laser process in which a heat process is performed. In an ablation process, the repetition frequency is set to an appropriate value that is not excessively large so that only the surface layer of the workpiece is cut without giving a heat thereto. Thus, an ablation process is a so-called “cool cutting” process, and is characteristic in that substantially no thermal influence is given to the workpiece.

However, an actual attempt to process a workpiece with an ultra-short pulse laser beam showed the following problem. Specifically, when a hole 500 was made in a workpiece 502, a portion of the workpiece 502 was, in some cases, chipped off to form a notch 501 at a specific location on the edge of the hole 500 on the reverse side of the workpiece 502 (i.e., opposite to the side of the workpiece 502 irradiated with a laser beam), as illustrated in FIG. 13 and FIG. 14, resulting in a process defect. If such a process defect occurs in forming a nozzle of an ink jet head, the ink droplet discharging direction or the ink droplet discharging velocity is varied, thereby significantly lowering the ink discharging performance of the ink jet head. Therefore, a technique for suppressing the occurrence of a notch as described above has been waited for in the art.

### SUMMARY OF THE INVENTION

An object of the present invention is to suppress the occurrence of a notch in a material as described above, and to improve the process precision.

Another object of the present invention is to precisely form a minute nozzle in a nozzle plate of an ink jet head.

A laser processing method of the present invention is a laser processing method, including the step of processing a material using a laser beam wherein a placement position z of a material with respect to a direction of an optical path of the laser beam is set to be −20 μm to +25 μm, where z is 0 at a reference position at which, when a hole is formed in the material, a diameter of the hole is minimum, and z increases as the placement position is moved closer to a source of the laser beam and decreases as the placement position is moved away from the source of the laser beam.

In this way, the occurrence of a notch in the material is suppressed.

In the laser processing method, it is preferred that the material is scanned with the laser beam by moving an irradiation position of the laser beam on the material at a scanning speed of 40 μm/s to 300 μm/s.

The above processing method may be applied to a laser processing method for forming a hole in the material using a laser beam.

The hole formed in the material may have a greater opening diameter on one side of the material that is irradiated with the laser beam than on the other side of the material. Note that the hole; diameter may change continuously or stepwise. Alternatively, the hole may include a portion in which the hole diameter changes continuously and another portion in which the hole diameter changes stepwise.

The hole formed in the material may include a tapered portion whose diameter increases in an upward direction and a through hole portion having a constant hole diameter.

In the laser processing method, it is preferred that the material is scanned with the laser beam by moving an irradiation position of the laser beam on the material from a center side toward a peripheral side of the hole.

In this way, the formation of the hole with the laser beam starts from the center side of the hole. The opening made in the central portion of the hole to be formed is then gradually expanded outward. Since the hole diameter is small in the beginning of the hole making process, the laser beam is likely to be diffracted on the reverse side of the hole. Therefore, in the beginning of the process, a notch is likely to be formed on the reverse side of the hole. However, as described above, the hole is gradually expanded as the process proceeds, whereby the peripheral portion of the initially formed opening will eventually be removed by the laser beam. Therefore, the notch occurring in the beginning of the process will be removed by the laser beam. As a result, a notch as described above is unlikely to occur.

In the laser processing method, it is preferred that the placement position z is set to be 0 to +10 μm.

In this way, the occurrence of a notch on the reverse side of the hole is suppressed.

In the laser processing method, it is preferred that the material is scanned with the laser beam by moving an irradiation position of the laser beam on the material at a scanning speed of 40 μm/s to 300 μm/s.

In the laser processing method, it is preferred that the material is scanned with the laser beam by moving an irradiation position of the laser beam on the material from a center side toward a peripheral side of the hole.

It is preferred that the laser beam has a pulse width of 0.1 ps to 100 ps.

It is preferred that the laser beam has a wavelength of 2 μm or less.

Another laser processing method of the present invention is a laser processing method for forming a nozzle in a nozzle plate of an ink jet head by using a laser beam, the method including the steps of diffracting the laser beam, which is output from a laser, into a plurality of laser beams; and irradiating the nozzle plate with the plurality of laser beams so as to form a plurality of nozzles therein, wherein in the formation of each nozzle, a placement position z of the nozzle plate with respect to a direction of an optical path of the laser beam is set to be −20 μm to +25 μm, where z is 0 at a reference position at which a hole diameter of the nozzle is minimum, and z increases as the placement position is moved closer to a source of the laser beam and decreases as the placement position is moved away from the source of the laser beam.

In this way, a plurality of nozzles are simultaneously formed in the nozzle plate, and the occurrence of a notch is suppressed in each of the nozzles.

It is preferred that the placement position z is set to be 0 to +10 μm.

In this way, the occurrence of a notch is suppressed in each of the nozzles.

A laser processing apparatus of the present invention is a laser processing apparatus, including a laser, wherein a placement position z of a material with respect to a direction of an optical path of the laser beam is set to be −20 μm to +25 μm, where z is 0 at a reference position at which, when a hole is formed in the material, a diameter of the hole is minimum, and z increases as the placement position is moved closer to a source of the laser beam and decreases as the placement position is moved away from the source of the laser beam.

In this way, the occurrence of a notch in the material is suppressed.

It is preferred that the laser processing apparatus further includes a scanning mechanism for scanning the material with the laser beam by moving an irradiation position of the laser beam on the material, wherein a scanning speed is set to be 40 μm/s to 300 μm/s.

It is preferred that the laser processing apparatus further includes a scanning mirror for scanning the material with the laser beam by moving an irradiation position of the laser beam on the material, wherein a scanning speed is set to be 40 μm/s to 300 μm/s.

It is preferred that the placement position z is set to be 0 to +10 μm.

In this way, the occurrence of a notch in the material is suppressed.

It is preferred that the laser processing apparatus further includes a scanning mechanism for scanning the material with the laser beam by moving an irradiation position of the laser beam on the material, wherein a scanning speed is set to be 40 μm/s to 300 μm/s.

It is preferred that the laser processing apparatus further includes a scanning mirror for scanning the material with the laser beam by moving an irradiation position of the laser beam on the material, wherein a scanning speed is set to be 40 μm/s to 300 μm/s.

It is preferred that the laser outputs a laser beam having a pulse width of 0.1 ps to 100 ps.

It is preferred that the laser outputs a laser beam having a wavelength of 2 μm or less.

A nozzle plate of the present invention is a nozzle plate having a nozzle formed therein by using a laser beam, wherein in the formation of the nozzle, a placement position z of the nozzle plate with respect to a direction of an optical path of the laser beam is set to be −20 μm to +25 μm, where z is 0 at a reference position at which a hole diameter of the nozzle is minimum, and z increases as the placement position is moved closer to a source of the laser beam and decreases as the placement position is moved away from the source of the laser beam.

An ink jet head of the present invention is an ink jet head, including a nozzle plate having a nozzle formed therein by using a laser beam, wherein in the formation of the nozzle, a placement position z of the nozzle plate with respect to a direction of an optical path of the laser beam is set to be −20 μm to +25 μm, where z is 0 at a reference position at which a hole diameter of the nozzle is minimum, and z increases as the placement position is moved closer to a source of the laser beam and decreases as the placement position is moved away from the source of the laser beam.

An ink jet recording apparatus of the present invention is an ink jet recording apparatus, including an ink jet head, wherein: the ink jet head includes a nozzle plate having a nozzle formed therein by using a laser beam; and in the formation of the nozzle, a placement position z of the nozzle plate with respect to a direction of an optical path of the laser beam is set to be −20 μm to +25 μm, where z is 0 at a reference position at which a hole diameter of the nozzle is minimum, and z increases as the placement position is moved closer to a source of the laser beam and decreases as the placement position is, moved away from the source of the laser beam.

### BRIEF DESCRIPTION OF THE DRAWINGS

FIG. 1 illustrates a configuration of a laser processing system.

FIG. 2 illustrates a configuration of an oscillator.

FIG. 3 illustrates a configuration of a regenerative amplifier.

FIG. 4 is a cross-sectional view illustrating a nozzle plate.

FIG. 5 is an electron microscope picture showing a nozzle plate.

FIG. 6 is a cross-sectional view illustrating an ink jet head.

FIG. 7 is a perspective view illustrating an important part of an ink jet printer.

FIG. 8A to FIG. 8C illustrate a nozzle forming method.

FIG. 9 is a graph illustrating the relationship between the placement position and the hole diameter.

FIG. 10A to FIG. 10J are each an optical microscope picture showing the surface condition of a processed surface.

FIG. 11 is a graph illustrating the relationship between the placement position and the process defect rate.

FIG. 12 is a perspective view illustrating a pate to be cut.

FIG. 13 is an electron microscope picture showing a nozzle plate with a notch occurring at a location on the periphery of a nozzle.

FIG. 14 is a cross-sectional view taken along line XIV-XIV of FIG. 13.

### DESCRIPTION OF THE PREFERRED EMBODIMENT

An embodiment of the present invention will now be described with reference to the drawings.

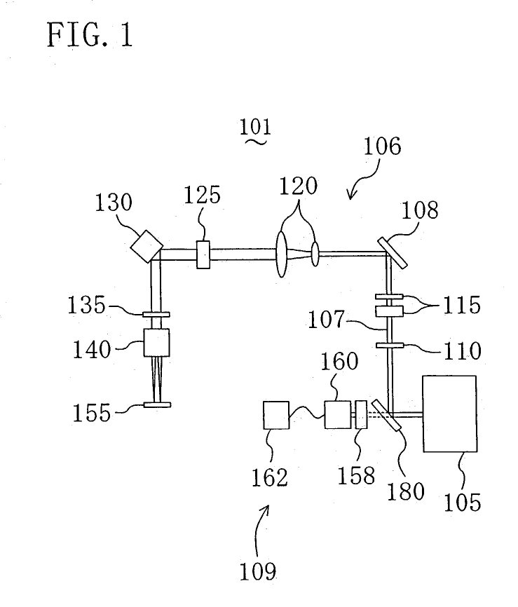

FIG. 1 illustrates a configuration of an ultra-short pulse laser processing system 101 of the present embodiment. The laser processing system 101 includes a laser generation apparatus 105 for outputting an ultra-short pulse laser beam, a laser control apparatus (not shown) for controlling the laser generation apparatus 105, an optical system 106, an optical system control apparatus (not shown) for controlling the optical system 106, and a measurement apparatus 109 for measuring an ultra-short pulse laser beam. A laser beam whose pulse width is 0.1 ps to 100 ps, for example, can suitably be used as the ultra-short pulse laser beam.

The optical system 106 includes a first mirror 180 for reflecting an ultra-short pulse laser beam 107 output from the laser generation apparatus 105, a shutter 110, an attenuator 115, a second mirror 108, a beam expander 120, a wave plate 125, a scan mirror 130, a DOE (Diffractive Optical Element) 135, and a telecentric lens 140. A workpiece 155 is placed at the-end of the path of the laser beam 107. The attenuator 15, including a phase plate and a polarizer, is used for adjusting the intensity of the laser beam 107.

A portion of the laser beam 107 output from the laser generation apparatus 105 is reflected by the first mirror 180. The laser beam 107 reflected by the first mirror 180 passes through the shutter 110, and then through the attenuator 115. The laser beam 107, having passed through the attenuator 115, is reflected by the second mirror 108 and expanded by the beam expander 120 with an appropriate magnification so as to be a collimated beam. Then, the collimated laser beam 107 passes through the wave plate 125 for adjusting the polarization direction and is reflected by the scan mirror 130, after which it passes through the DOE 135. The laser beam 107 is diffracted by the DOE 135 into a plurality of beams.

The diffracted beams are focused through the telecentric lens 140 each into a beam having a diameter of about 10 to 15 μm, for example, and reach the workpiece 155, thereby processing the workpiece 155. While the workpiece 155 is processed, the beams can be moved with respect to the workpiece 155 by swinging the scan mirror 130. Thus, the surface of the workpiece 155 can be shaven off in laminar shapes, and the workpiece 155 can be processed into an intended three-dimensional shape.

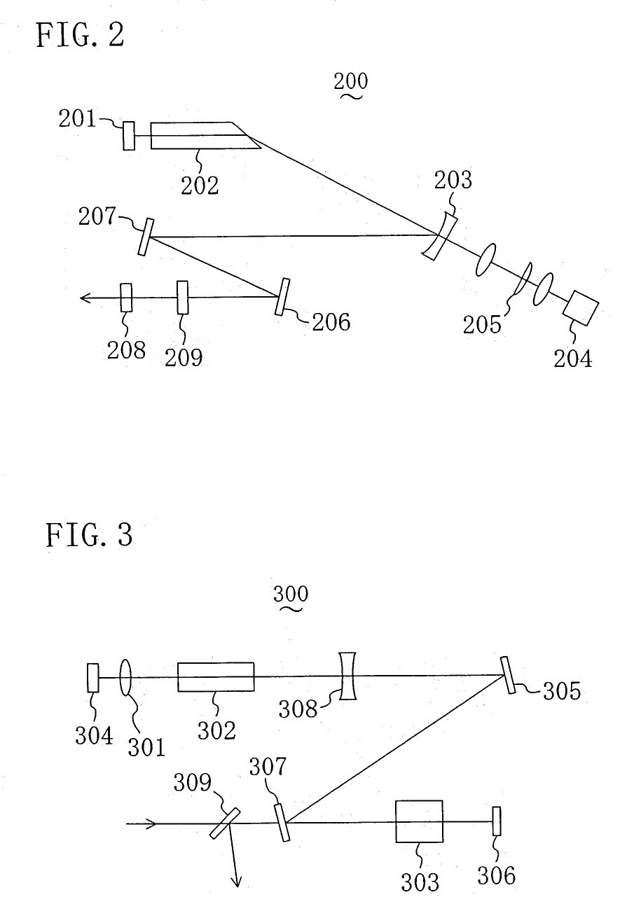

Next, the configuration of the laser generation apparatus 105 will be described in detail. The laser generation apparatus 105 includes an oscillator 200 as illustrated in FIG. 2, and a regenerative amplifier 300 as illustrated in FIG. 3. In the laser generation apparatus 105, the oscillator 200 generates a pulse laser beam, and the regenerative amplifier 300 cuts out a pulse from the pulse laser beam at a predetermined frequency and amplifies the cut-out pulse so as to output the amplified pulses.

As illustrated in FIG. 2, the oscillator 200 includes a pump laser 204, a control apparatus (not shown) for controlling the temperature of the pump laser 204, a lens 205, a laser medium 202, a Q switching element 207, a pulse stretcher 209, an output coupler 208, and reflection mirrors 201, 203 and 206.

As illustrated in FIG. 3, the regenerative amplifier 300 includes a pump laser 304, a laser medium 302, a Q switching element 303, a polarizer 307, an output coupler 309, reflection mirrors 305 and 306, and lenses 301 and 308.

Although not shown, the laser control apparatus includes a pump laser driver, a pump laser temperature control driver, a Q switching element driver, a Q switching delay time control apparatus, a shutter driver, and a scan mirror driver. The pump laser driver adjusts the output of the pump laser by controlling the current to be given to the pump laser. The pump laser temperature control driver controls the temperature of the pump laser, and keeps the pump laser at a constant temperature. The Q switching element driver gives a signal voltage to the Q switching element. The Q switching delay time control apparatus controls the delay time with which the Q switching element driver is operated. The shutter driver closes/opens the shutter 110 for blocking/transmitting the laser beam 107. The scan mirror driver gives a signal to the driving section of the scan mirror 130 so as to adjust the scan mirror 130 to an intended angle.

The measurement apparatus 109 includes a diffuser 158, a photodetector 160 and an oscilloscope 162. In the measurement apparatus 109, a laser beam, having passed through the first mirror 180, is diffused by the diffuser 158 into an isotropic laser beam. Then, the number of photons of the laser beam is measured by the photodetector 160. The number of photons is converted to a voltage value, and is measured by the oscilloscope 162. The oscilloscope 162 outputs the waveform of the voltage value.

The type of workpiece to be processed by the laser processing system 101 is not limited to any particular type of workpiece. For example, the laser processing system 101 can be used for processing a nozzle plate of an ink jet head, as described below, to form nozzles therein.

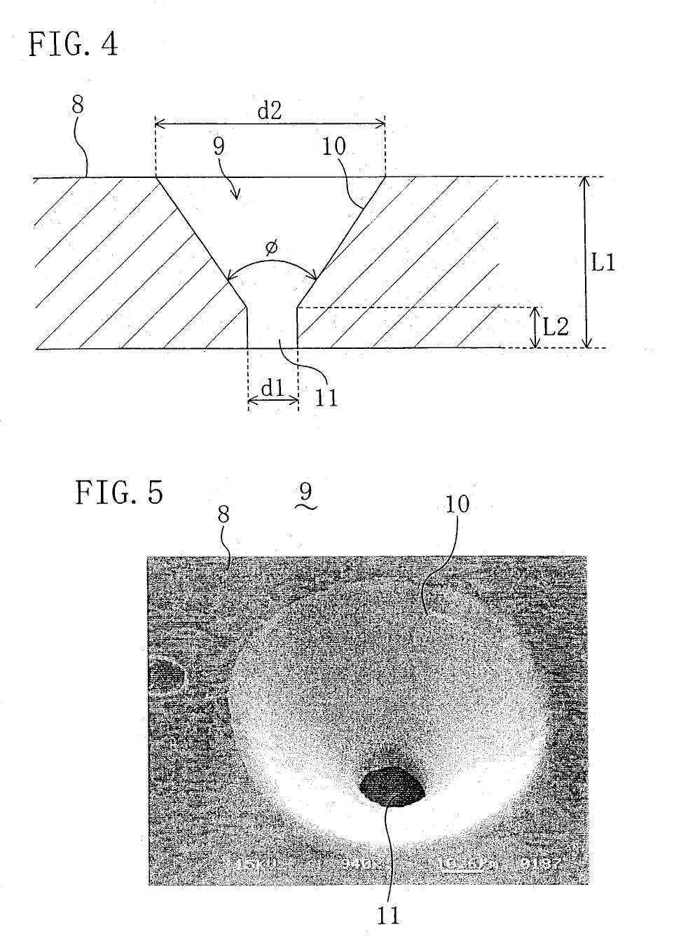

In the present embodiment, the workpiece is a nozzle plate 8 as illustrated in FIG. 4 and FIG. 5. An upper portion of a nozzle 9 of the nozzle plate 8 is formed into a tapered portion 10 so that the inner diameter increases in the upward direction, with a lower portion thereof being a through hole 11 having a constant inner diameter. Although the shape and the dimension of the nozzle plate 8 and the nozzle 9 are not limited to any particular shape or dimension, an example of the nozzle plate 8 and the nozzle 9 that can suitably be used is such that the thickness L1 of the nozzle plate 8 is 50 μm, the length L2 of the through hole 11 having a constant inner diameter is 10 μm, the inner diameter d1 of the through hole 11 is 20 μm, the maximum inner diameter d2 of the tapered portion 10 is 85 μm, and the taper angle φ is 80°.

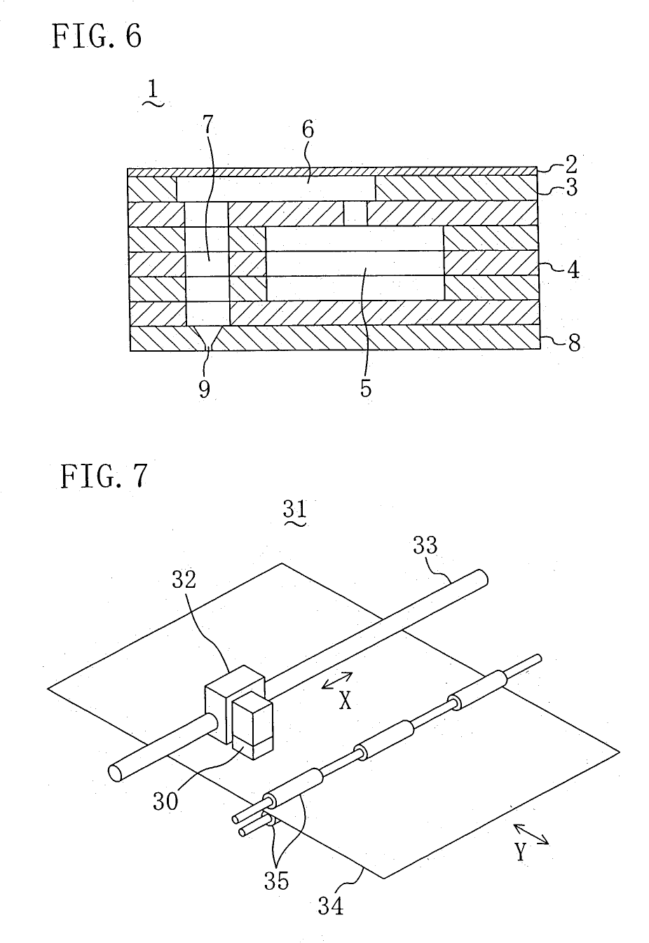

As illustrated in FIG. 6, an ink jet head 1 includes the nozzle plate 8, a head body 4 obtained by layering a plurality of stainless steel plates together, a pressure chamber forming plate 3 made of a photosensitive glass, and a piezoelectric actuator 2, which are layered together. Although not shown in FIG. 6, the nozzle plate 8 includes a number of nozzles 9 arranged in a direction perpendicular to the sheet of FIG. 6.

A plurality of pressure chambers 6 communicated to the respective nozzles 9 via ink channels 7, and a common ink chamber 5 communicated to the pressure chambers 6, are provided inside the ink jet head 1.

FIG. 7 illustrates a general structure of an ink jet printer 31 using the ink jet head 1 therein. The ink jet head 30 is fixed to a carriage 32 that is provided with a carriage motor (not shown). The carriage 32 is reciprocally moved by the carriage motor in a primary scanning direction X while being guided by a carriage shaft that extends in the primary scanning direction X. Therefore, the ink jet head 30 is also reciprocally moved in the primary scanning direction X.

Recording paper 34 is sandwiched between two carrier rollers 35 rotated by a carrier motor (not shown), and is carried in a secondary scanning direction Y perpendicular to the primary scanning direction X by the carrier motor and the carrier rollers 35.

Note however that the recording apparatus of the present invention is not limited to the printer 31 as described above, but the present invention may alternatively be applied to other types of printers. Moreover, the recording apparatus of the present invention is not limited to a printer, but may alternatively be any other type of recording apparatus having an ink jet head therein, such as a copier or a facsimile.

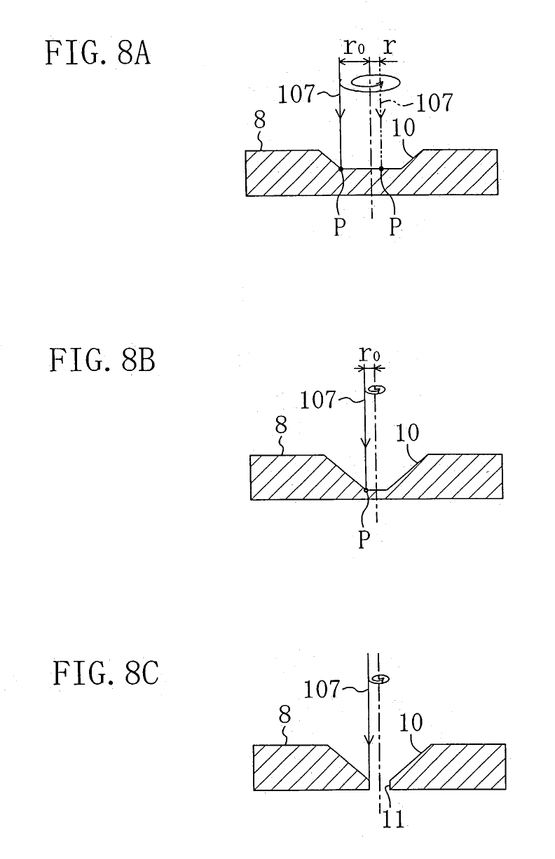

Next, a method for processing the nozzle plate 8 to form the nozzle 9 therein will be described. The nozzle 9 of the present embodiment is formed by a milling method as described below. As illustrated in FIG. 8A to FIG. 8C, the laser beam 107 is swung so that the irradiation position P to which the laser beam 107 reaches is rotated in a spiral pattern on the nozzle plate 8. The swinging of the laser beam 107 is performed through a number of steps according to the depth of the nozzle 9.

Specifically, as illustrated in FIG. 8A, in a step of forming the tapered portion 10 to a predetermined depth, the irradiation position P of the laser beam 107 is rotated while gradually decreasing the radius r of rotation starting from a predetermined initial radius r0. After the irradiation position P reaches the center of rotation, the irradiation position P is rotated while gradually increasing the radius r to the initial radius r0. In this way, a single layer of the surface of the nozzle plate 8 is removed by an ablation process. Then, in the next step of forming the tapered portion 10 to another depth that is one step greater than the predetermined depth, the laser beam 107 is swung as described above by using another initial radius that is slightly smaller than the initial radius r0. The tapered portion 10 whose inner diameter increases in the upward direction is formed by performing such a process through a number of steps.

After forming the tapered portion 10, the through hole 11 is formed. When forming the through hole 11, the laser beam 107 is swung as described above with the initial radius being fixed to the predetermined radius of the through hole 11. In this way, the through hole 11 having a constant inner diameter is formed by an ablation process. Alternatively, the irradiation position P of the laser beam 107 may be rotated circumferentially with the radius of rotation being fixed to the initial radius.

Moreover, when forming the through hole 11, the irradiation position P may be moved from the center side toward the peripheral side of the hole. The irradiation position P may be moved in a circular pattern or in a linear pattern. In this way, the formation of the hole with a laser beam starts from the center side and then gradually proceeds outward. Therefore, even if a notch is formed on the reverse side of the workpiece when an opening is first made in the central portion of a hole to be formed, such a notch will be removed through the subsequent process. Thus, the notch is eventually removed by the laser beam. Therefore, in this way, a notch is less likely to occur.

### EXAMPLE

Next, an example will be described. In this example, a pico-second pulse laser with an Nd:YLF laser medium was used as an ultra-short pulse laser. A 1 W semiconductor laser diode was used as the pump laser 204 of the oscillator 200, an Nd:YLF laser medium as the laser medium 202, and a SESAM (SEmiconductor Saturable Absorber Mirror) as the Q switching element 207. With such a configuration, the oscillator 200 realized laser oscillation with a frequency of 80 MHz, a pulse width of 15 ps (pico-seconds) and an output of 35 mW.

In the regenerative amplifier 300, a 16 W semiconductor laser diode was used as the pump laser 304, an Nd:YLF laser medium as the laser medium 302, and a Pockels cell as the Q switching element 303. With the regenerative amplifier 300, an output of 1 W was finally obtained with a repetition frequency of 1 kHz. As a result, the pulse laser beam output by the regenerative amplifier 300 had a pulse width of 15 ps, a wavelength of 1053 nm, a repetition frequency of 1 kHz, and a bandwidth of about 0.1 ns.

In the measurement apparatus 109, a laser beam leaking from the first mirror 180 was input to the photodetector 160 after it was attenuated by the diffuser 158. The laser output was measured in this way. A high-speed silicon detector DET210 manufactured by THORLABS Inc. was used as the photodetector 160. The rise time of the detector is less than 1 ns, and the diode capacitance thereof is 1.8 pF. Photons in the laser beam 107 are counted at a rise time of the detector, and converted into an electric signal at a relaxation time corresponding to the rise time.

The electric signal obtained in the photodetector 160 is input to the oscilloscope 162 via a 50 Ω BNC cable. The time dependency of the laser output is observed as a waveform on the oscilloscope 162. As the oscilloscope 162, a digital oscilloscope TDS3052B manufactured by Sony/Tektronix Corporation was used. The sampling frequency of the oscilloscope was 5 GHz, and the bandwidth thereof was 500 MHz. The electric signal from the photodetector 160 is displayed as a function of time at a relaxation time according to the bandwidth of the digital oscilloscope.

Thermal SmartSensors Standard Sensors 33-1025 manufactured by COHERENT Inc. was used for measuring the static power of the laser. When the power as measured by the wattmeter was 1 W, the maximum value of the pulse waveform in the photodetector was 400 mV. Note that this value is not an absolute reference as the value depends on where the photodetector is placed, the type of the diffuser used, etc.

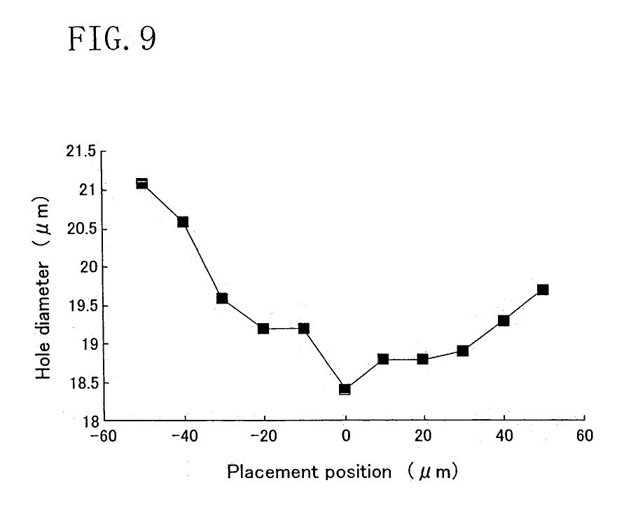

With such a configuration, the following experiment was conducted. The purpose of the experiment was to examine the correlation between the “placement position” (i.e., the position at which the workpiece is placed) with respect to the laser beam and the condition of the processed portion. A plate made of a stainless steel (SUS304) and having a thickness of 50 μm was used as the workpiece. In the experiment, the placement position is defined as a position of the reverse side (i.e., the surface opposite to the irradiated surface) of the workpiece. In the experiment, the workpiece was processed with an ablation rate determined so that the through hole of the nozzle would have an inner diameter of about 20 μm, while changing the position of the workpiece by the step of 10 μm. The results of the experiment are shown in FIG. 9.

FIG. 9 illustrates the relationship between the placement position and the inner diameter of the obtained hole (i.e., the through hole of the nozzle). The horizontal axis represents the position z of the workpiece relative to the reference position (z=0) with respect to the direction of the optical path of the laser beam, wherein the symbol “+” indicates that the position is closer to the light source of the laser beam than the reference position, and the symbol “−” indicates that the position is farther away from the light source of the laser beam than the reference position. The vertical axis represents the diameter of the hole obtained. As to the horizontal axis, the position at which the hole had the smallest diameter was used as the reference position (z=0). With respect to the depth of focus of the laser beam, FIG. 9 shows a distribution such that the hole diameter variation is greater on the − side than on the + side, in other words, an asymmetric distribution.

A laser beam has a divergence angle on the front side and the rear side of the focal point, and thus the beam diameter generally increases on the front side and the rear side of the focal point from that in the focal point. The intensity distribution of the beam before being diffracted by the DOE 135 was a very good Gaussian distribution, and as to the beam quality, the M2 value was 1.02. However, the intensity distribution of the beam after passing through the DOE 135 and the telecentric lens 140 is not simple. Particularly, it is believed that the distribution is not a Gaussian distribution on the front side and the rear side of the focal point. The focal point dependency of the intensity distribution can be known by observing the actual condition of the processed portion.

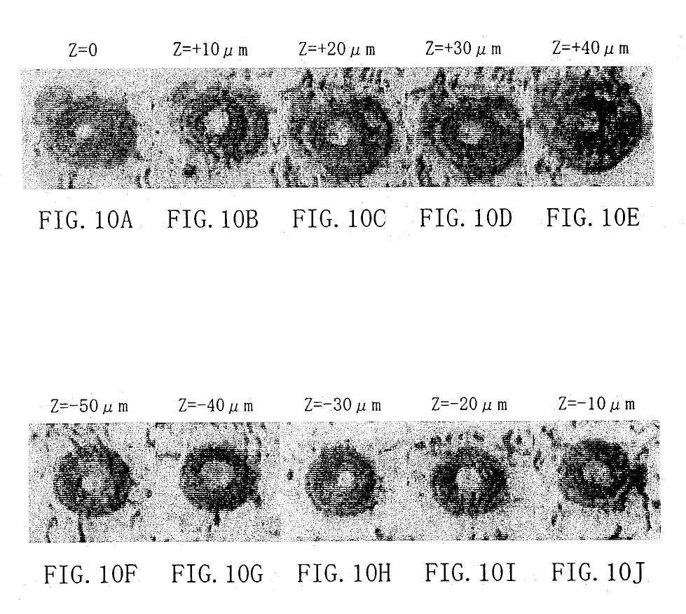

FIG. 10A to FIG. 10J show the results of the experiment in which the position of the workpiece was changed by the step of 10 μm. Each of FIG. 10A to FIG. 10J is an optical microscope picture showing the surface condition of the processed surface. The workpiece was irradiated with a laser beam including 100 short pulses, and the laser beam was not swung. With the number of pulses being set to 100, the process time was as short as 0.1 second, and the portion was processed by the laser beam into a beam track rather than a through hole. Therefore, the beam track made by the laser beam was observed clearly, and it was relatively easy to grasp the beam intensity distribution.

In FIG. 10A to FIG. 10J, the central portion in each beam track appears white due to reflection because the central portion is processed with a high energy to be a smooth surface and thus reflects a larger amount of light from the microscope. The central portion is a portion where the laser beam was strongest in terms of energy. The surrounding black portion is a portion that was processed with the laser beam having a lower energy to be a rough surface, and is thus absorbing light from the microscope. And, this black portion looks like a beam track.

It is assumed that the laser beam intensity distribution is approximately a Gaussian distribution in the vicinity of the reference position (z=0). However, at positions away from the reference position by a few tens of micrometers or more, another beam track is observed around the central annular beam track, and is implying a distribution like a polynomial of order six. Thus, the experiment suggests that a shift in the placement position in an ultra-short pulse laser process causes an adverse effect more significantly than that a person of ordinary skill in the art would normally imagine to be simply caused by a laser beam being “out of focus”.

In the next experiment, tapered nozzles were actually formed while changing the placement position of the workpiece by the step of 10 μm with respect to the above placement position. A stainless steel SUS304 manufactured by Hirai Seimitsu Kogyo Corporation, Japan having a thickness of 50 μm was used as the workpiece. The laser beam was swung by the PZT scan mirror 130, and was diffracted into 400 beams by the DOE 135, so as to simultaneously form 400 nozzles by the milling method described above. The laser beam scanning speed was set to be 40 μm/s to 300 μm/s. The scan mirror 130 was controlled by using a scan mirror control apparatus (not shown). The scan mirror control apparatus logically calculates the path along which the, scan mirror should be moved for forming nozzles of a predetermined shape and dimension, and moves the scan mirror along the calculated path. The scan mirror control apparatus operates according to a predetermined program. In this experiment, the shape of the tapered portion 10 of the nozzle 9 (see FIG. 4) was such that the hole diameter d2 at its entrance was about 80 μm, the hole diameter d1 at its exit was 20 μm±0.5 μm, and the depth L1-L2 was 40 μm±0.5 μm.

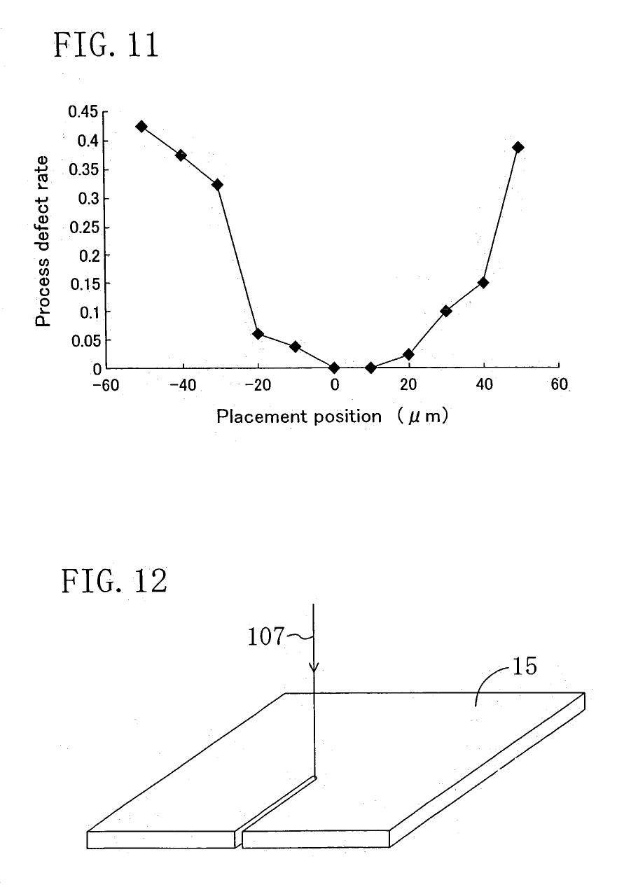

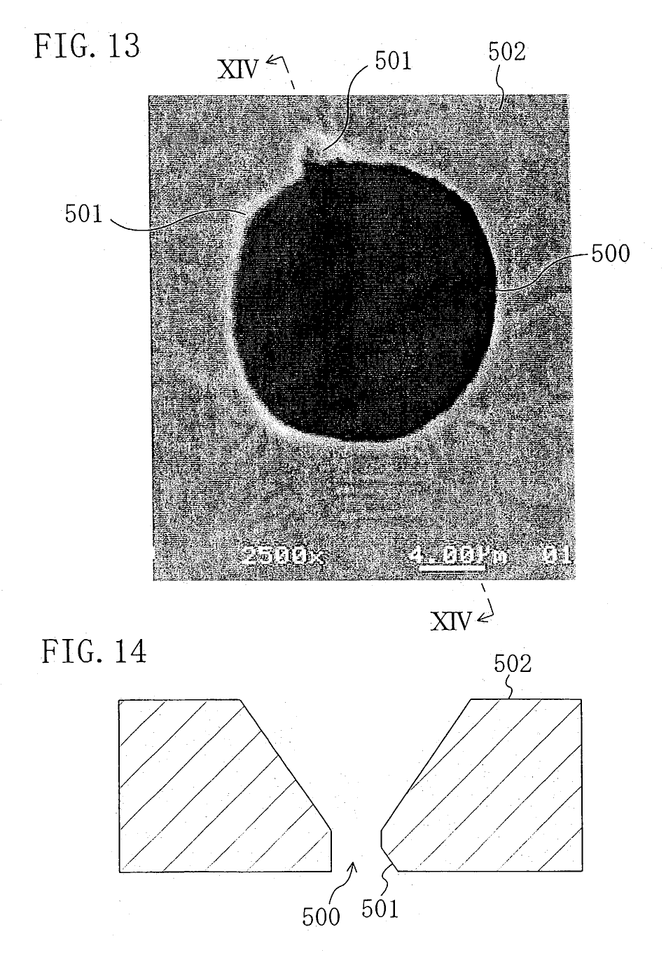

As a result of the experiment, for some of the placement positions, a notch was observed at the periphery of the nozzle hole at its exit (i.e., on the exit side of the through hole), indicating a process defect. Among a total of 400 nozzles actually formed, 80 nozzles were randormly selected, and the number of nozzles with a notch was counted among the selected 80 nozzles. The ratio of defective nozzles with respect to the 80 nozzles was calculated as the process defect rate. The results are shown in Table 1 below and in FIG. 11.

TABLE 1

| | Placement | Number of defective holes | Process defect |
|---|---|---|---|
| Sample # | position (μm) | (among 80) | rate |
| 1 | −50 | 34 | 0.425 |
| 2 | −40 | 30 | 0.375 |
| 3 | −30 | 26 | 0.325 |
| 4 | −20 | 5 | 0.0625 |
| 5 | −10 | 3 | 0.0375 |
| 6 | 0 | 0 | 0 |
| 7 | 10 | 0 | 0 |
| 8 | 20 | 2 | 0.025 |
| 9 | 30 | 8 | 0.1 |
| 10 | 40 | 12 | 0.15 |
| 11 | 50 | 31 | 0.3875 |

FIG. 11 is a graph illustrating the relationship between the placement position z of the workpiece and the process defect rate. The relationship between the placement position and the process defect rate shown in FIG. 11 shows a similar tendency as that in the relationship between the placement position and the process hole diameter shown in FIG. 9.

In the range between the reference position (z=0) and the position at a distance of 10 μm forward (z=+10 μm), a process defect occurred in none of the 80 nozzles. It can be seen that the process defect rate can be suppressed to be about 6.5% or less, whereby a desirable process can be realized, in the range between a position at a distance of 25 μm forward from the reference position (z=+25 μm) and a position at a distance of 20 μm backward (z=−20 μm).

A similar experiment was conducted while changing the energy of the laser beam by using the attenuator 115. Similar results were obtained in the range of z=+25 μm to z=−20 μm, though the process defect rate increased/decreased outside the range of z=+25 μm to z=−20 μm. Moreover, a similar experiment was conducted while changing the control signal for the Pockels cell. Again, similar results to those described above were obtained in the range of z=+25 μm to z=−20 μm.

These experiment results gave the following findings 1) to 3):

1) The occurrence of a notch at the exit of a nozzle has a strong correlation with the distance from the reference position (z=0) at which the diameter of the hole is minimum.

2) The numerical range of the placement position for preventing or suppressing the occurrence of a notch is quite limited.

3) The frequency of occurrence of a notch shows an asymmetric distribution with respect to the reference position.

The above findings 1) to 3) are totally novel in the art, and can be used as guidelines in providing a processing technique that is more precise and accurate than those in the prior art. The present invention is based on these guidelines, and thus provides advantageous effects that cannot be derived from the guidelines in the prior art of simply aligning the placement position of the workpiece with the focal point.

It is logically inferred that the wavelength of the laser beam would substantially influence the process precision in a minute process as described above. When processing a portion of a workpiece that has about the same size as the wavelength, optical diffraction occurs in the processed portion. Therefore, a process defect as described above is more likely to occur as the wavelength is shorter. Particularly, when performing a sub-micron process, in which the dimension of the processed portion is 2 μm or less, by using a laser beam whose wavelength is 2 μm or less, it is difficult to prevent or suppress the process defect without taking some measures. Therefore, the present invention is particularly effective when using a laser beam whose wavelength is 2 μm or less. For example, a laser beam whose wavelength is 0.1 μm to 2 μm can suitably be used, or a laser beam whose wavelength is 0.2 μm to 0.4 μm can be used.

Note that “the placement position of the workpiece with respect to the direction of the optical path of the laser beam at which the diameter of the hole formed in the workpiece is minimum” as defined herein can be regarded as being substantially equivalent to the focal point as measured by a commercially-available laser beam profiler.

The above embodiment exemplifies a method for forming a hole in a workpiece. However, the laser processing method and the laser processing apparatus according to the present invention are not limited to those for forming a hole. For example, the present invention may be applied for cutting a workpiece using the laser beam. In detail, as illustrated in FIG. 12, a plate 15 may be cut by irradiating the laser beam 107 to the plate 15.

The present invention is not limited to the embodiment set forth above, but may be carried out in various other ways without departing from the spirit or main features thereof.

Thus, the embodiment set forth above is merely illustrative in every respect, and should not be taken as limiting. The scope of the present invention is defined by the appended claims, and in no way is limited to the description set forth herein. Moreover, any variations and/or modifications that are equivalent in scope to the claims fall within the scope of the present invention.

What is claimed is:

1. A laser processing method, comprising the step of processing a material using a laser beam, wherein a placement position z of a material with respect to a direction of an optical path of the laser beam is set to be −20 μm to +25 μm, where z is 0 at a reference position at which, when a hole is formed in the material, a diameter of the hole is minimum, and z increases as the placement position is moved closer to a source of the laser beam and decreases as the placement position is moved away from the source of the laser beam.

2. The laser processing method of claim 1, wherein the material is scanned with the laser beam by moving an irradiation position of the laser beam on the material at a scanning speed of 40 μm/s to 300 μm/s.

3. The laser processing method of claim 1, wherein the step of processing a material includes a step of forming a hole in the material using a laser beam, and the hole formed in the material has a greater opening diameter on one side of the material that is irradiated with the laser beam than on the other side of the material.

4. The laser processing method of claim 1, wherein the step of processing a material includes a step of forming a hole in the material using a laser beam, and the hole formed in the material includes a tapered portion whose diameter increases in an upward direction and a through hole portion having a constant hole diameter.

5. The laser processing method of claim 1, wherein the step of processing a material includes a step of forming a hole in the material using a laser beam, and the material is scanned with the laser beam by moving an irradiation position of the laser beam on the material from a center side toward a peripheral side of the hole.

6. The laser processing method of claim 1, wherein the placement position z is set to be 0 to +10 μm.

7. The laser processing method of claim 6, wherein the material is scanned with the laser beam by moving an irradiation position of the laser beam on the material at a scanning speed of 40 μm/s to 300 μm/s.

8. The laser processing method of claim 6, wherein the step of processing a material includes a step of forming a hole in the material using a laser beam, and the material is scanned with the laser beam by moving an irradiation position of the laser beam on the material from a center side toward a peripheral side of the hole.

9. The laser processing method of claim 1, wherein the laser beam has a pulse width of 0.1 ps to 100 ps.

10. The laser processing method of claim 1, wherein the laser beam has a wavelength of 2 μm or less.

11. A laser processing method for forming a nozzle in a nozzle plate of an ink jet head by using a laser beam, the method comprising the steps of:
diffracting the laser beam, which is output from a laser, into a plurality of laser beams; and
irradiating the nozzle plate with the plurality of laser beams so as to form a plurality of nozzles therein,
wherein in the formation of each nozzle, a placement position z of the nozzle plate with respect to a direction of an optical path of the laser beam is set to be −20 μm to +25 μm, where z is 0 at a reference position at which a hole diameter of the nozzle is minimum, and z increases as the placement position is moved closer to a source of the laser beam and decreases as the placement position is moved away from the source of the laser beam.

12. The laser processing method of claim 11, wherein the placement position z is set to be 0 to +10 μm.

13. A laser processing apparatus, comprising a laser, wherein a placement position z of a material with respect to a direction of an optical path of the laser beam is set to be −20 μm to +25 μm, where z is 0 at a reference position at which, when a hole is formed in the material, a diameter of the hole is minimum, and z increases as the placement position is moved closer to a source of the laser beam and decreases as the placement position is moved away from the source of the laser beam.

14. The laser processing apparatus of claim 13, further comprising a scanning mechanism for scanning the material with the laser beam by moving an irradiation position of the laser beam on the material, wherein a scanning speed is set to be 40 μm/s to 300 μm/s.

15. The laser processing apparatus of claim 13, further comprising a scanning mirror for scanning the material with the laser beam by moving an irradiation position of the laser beam on the material, wherein a scanning speed is set to be 40 μm/s to 300 μm/s.

16. The laser processing apparatus of claim 13, wherein the placement position z is set to be 0 to +10 μm.

17. The laser processing apparatus of claim 16, further comprising a scanning mechanism for scanning the material with the laser beam by moving an irradiation position of the laser beam on the material, wherein a scanning speed is set to be 40 μm/s to 300 μm/s.

18. The laser processing apparatus of claim 16, further comprising a scanning mirror for scanning the material with the laser beam by moving an irradiation position of the laser beam on the materials wherein a scanning speed is set to be 40 μm/s to 300 μm/s.

19. The laser processing apparatus of claim 13, wherein the laser outputs a laser beam having a pulse width of 0.1 ps to 100 ps.

20. The laser processing apparatus of claim 13, wherein the laser outputs a laser beam having a wavelength of 2 μm or less.

21. A nozzle plate having a nozzle formed therein by using a laser beam, wherein in the formation of the nozzle, a placement position z of the nozzle plate with respect to a direction of an optical path of the laser beam is set to be −20 μm to +25 μm, where z is 0 at a reference position at which a hole diameter of the nozzle is minimum, and z increases as the placement position is moved closer to a source of the laser beam and decreases as the placement position is moved away from the source of the laser beam.

22. An ink jet head, comprising a nozzle plate having a nozzle formed therein by using a laser beam, wherein in the formation of the nozzle, a placement position z of the nozzle plate with respect to a direction of an optical path of the laser beam is set to be −20 μm to +25 μm, where z is 0 at a reference position at which a hole diameter of the nozzle is minimum, and z increases as the placement position is moved closer to a source of the laser beam and decreases as the placement position is moved away from the source of the laser beam.

23. An ink jet recording apparatus, comprising an ink jet head, wherein:
the ink jet head includes a nozzle plate having a nozzle formed therein by using a laser beam; and
in the formation of the nozzle, a placement position z of the nozzle plate with respect to a direction of an optical path of the laser beam is set to be −20 μm to +25 μm, where z is 0 at a reference position at which a hole diameter of the nozzle is minimum, and z increases as the placement position is moved closer to a source of the laser beam and decreases as the placement position is moved away from the source of the laser beam.
